(19) United States
(12) Patent Application Publication
(10) Pub. No.: US 2007/0139296 A1
(43) Pub. Date: Jun. 21, 2007

(54) Extra-monitor control circuit and transmission system for monitor

(76) Inventor: Heng Chun Ho, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/312,748

(22) Filed: Dec. 21, 2005

(51) Int. Cl. G09G 5/00

(52) U.S. Cl. 345/1.1

(57) ABSTRACT

An extra-monitor control circuit and transmission system for monitor includes an extra-monitor control circuit system having a scaler circuit, an On Screen Display (OSD) circuit, and a DC/DC converting circuit provided thereon. The extra-monitor control circuit system is located at a position outside a monitor and connected to the monitor via a transmission system consisting one single cable and connectors thereof. The one single cable and the connectors thereof transmit both signals and power to the monitor from a personal computer (PC) host to thereby reduce the monitor manufacturing cost and eliminate the problems of distorted signals and signal compatibility.

### FIELD OF THE INVENTION

The present invention relates to an extra-monitor control circuit and transmission system for a monitor, and more particularly to a monitor control circuit and transmission system that includes monitor control circuits and a DC/DC converting circuit, which are provided at a position outside the monitor to form either an independent unit adapted to insert into an expansion slot on a PC host or be integrated into a PC graphic card, and one single cable and connectors thereof for transmitting both signals and power from the PC host to the monitor, enabling reduced monitor manufacturing cost and enhanced monitor display quality.

### BACKGROUND OF THE INVENTION

Generally, circuits inside a liquid crystal display (LCD) monitor are divided into an LCD control module and an LCD panel module. The LCD control module is mainly used to communicate a personal computer (PC) host with the LCD panel module. FIG. 1 shows various control circuits included in the control module. As shown, the PC is internally provided with a graphic card 1, on which a main circuit 11 and a video Graphics Array (VGA) circuit 12 are provided. The graphic card 1 is connected to the monitor 3 via at least two cables 2 and connectors 21 thereof. The monitor 3 is internally provided with an On Screen Display (OSD) circuit 31, a scaler circuit 32, and a Low Voltage Differential Signal (LVDS) circuit 33. A separate cable is used to connect a city power source to an AC converting circuit 4 in the monitor 3, so that city power is converted by and supplied via the AC converting circuit 4 to the monitor 3 for use. In the above-described conventional monitor control circuit, since the monitor 3 has multiple types of circuits and cable connections, it requires higher manufacturing cost. Moreover, signals tend to become distorted after D/A and A/D conversions, and have the problem of poor compatibility with various circuits. Furthermore, since multiple cables 2 and connectors 21 are needed to connect the graphic card 1 to the monitor 3, complicate process and high cost are involved in manufacturing the monitor with internally provided control circuits and AC converting circuit.

### SUMMARY OF THE INVENTION

A primary object of the present invention is to provide a an extra-monitor control circuit and transmission system, which enables reduced monitor manufacturing cost and enhanced monitor display quality.

To achieve the above and other objects, the extra-monitor control circuit and transmission system according to the present invention includes an extra-monitor control circuit system for monitor that is located outside a monitor. The extra-monitor control circuit system includes a scaler circuit, an OSD circuit, and a DC/DC converting circuit. Signals and power are transmitted from the extra-monitor control circuit system to the monitor via the same cable and connectors thereof, so that the monitor manufacturing cost is reduced, and the problems of distorted signals and signal compatibility are eliminated.

In the present invention, the extra-monitor control circuit system may be independently formed for inserting into an expansion slot on a PC, or be integrated into a PC graphic card.

The DC/DC converting circuit of the extra-monitor control circuit system of the present invention converts power supplied from a power supply of the PC and supplies the converted power to the monitor. It is not necessary to provide a separate AC converting circuit in the monitor, and manufacturing cost for the monitor is reduced accordingly.

In the extra-monitor control circuit and transmission system of the present invention, only one single cable is provided to connect the extra-monitor control circuit system to the monitor. That is, the same cable and the connectors thereof are used to transmit both signals and power from the PC host to the monitor.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional control circuit system for a monitor; and

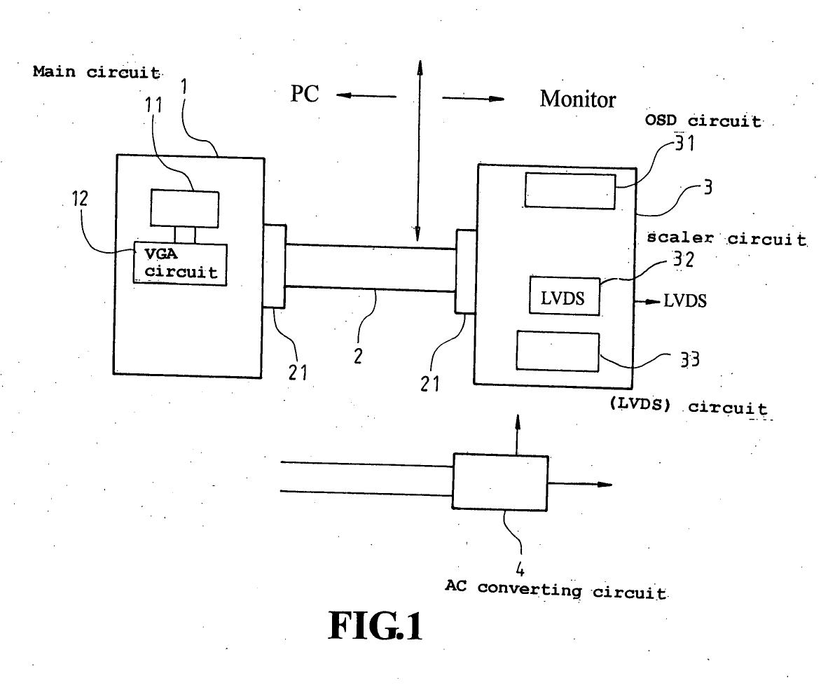

FIG. 2 is a block diagram of an extra-monitor control circuit and transmission system for monitor according to the present invention.

### DETAILED DESCRIPTION OF THE PREFERRED EMBODIMENTS

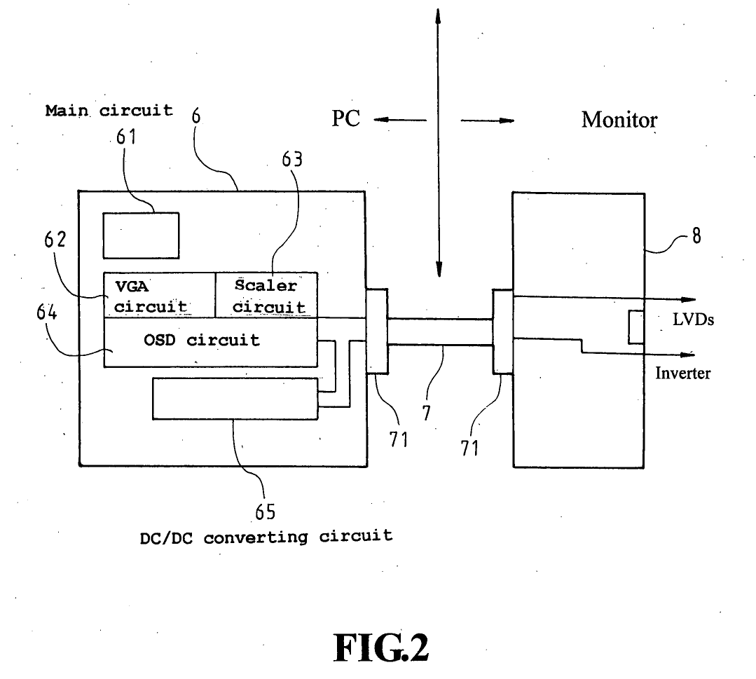

Please refer to FIG. 2 that is a block diagram of an extra-monitor control circuit and transmission system for monitor according to the present invention. As shown, the extra-monitor control circuit and transmission system of the present invention includes an extra-monitor control circuit system 6, in which a scaler circuit 63, an On Screen Display (OSD) circuit 64, and a DC/DC converting circuit 65 are provided. The extra-monitor control circuit system 6 of the present invention may be independently provided and inserted into an expansion slot on a personal computer (PC) for use, or be integrated into a PC graphic card, on which a main circuit 61 and a VGA circuit 62 are provided. The extra-monitor control circuit system 6 is connected to a monitor 8 via one single cable 7 and connectors 71 thereof. It is understood the number of contacts on the original connectors 71 is increased accordingly, so that both signals and power are transmitted via the one single cable 7 and the connectors 71 thereof.

The DC/DC converting circuit 65 provided on the extra-monitor control circuit system 6 converts and boosts the voltage of a PC power supply, so as to supply the power needed by the monitor 8. Therefore, the AC converting circuit 4 that is conventionally provided in the monitor for supplying power to the monitor is omitted in the present invention. In this manner, the manufacturing cost of the monitor can be reduced, and the monitor can be more conveniently assembled to reduce the bad yield possibly occurred during assembling of the monitor.

With the extra-monitor control circuit and transmission system according to the present invention, at least the following advantages can be achieved:
1. Since various control circuits conventionally provided inside a monitor are now provided on an extra-monitor control circuit system adapted to insert into a PC expansion slot or integrate into a PC graphic card, the process and the techniques required for manufacturing a monitor are simplified, and the manufacturing cost of the monitor is reduced, too.
2. The conventional A/D and D/A conversions are simplified in the integrated extra-monitor control circuit system, and the problem of distorted signals due to signal conversions can be avoided to achieve accurate digital signal transmission.
3. The provision of a control circuit block in a PC graphic card allows the best possible scaling function.
4. The extra-monitor control circuit system of the present invention is widely applicable to different monitor designs.
5. The problem of signal compatibility is eliminated, allowing the present invention to be widely employed in different types of monitors.
6. The transmission system between a PC and a monitor is simplified by using only one single cable and the connectors thereof to transmit both the signal and power supply needed by the monitor. This is also the reason why the monitor manufacturing process is simplified and the manufacturing cost thereof is reduced.

What is claimed is:

1. An extra-monitor control circuit and transmission system for monitor, comprising:
an extra-monitor control circuit system provided at a position outside a monitor;
a DC/DC converting circuit adapted to convert power supplied from a power supply of a personal computer (PC) host and supply the converted power to said monitor; and
a transmission system including one single cable and connectors thereof for connecting said PC host to said monitor to transmit both signals and power to said monitor from said PC host.
